(19) United States
(12) Patent Application Publication
(10) Pub. No.: US 2008/0215753 A1
(43) Pub. Date: Sep. 4, 2008

(54) Use of End-to-End Availability Calculations when Establishing a Connection

(76) Inventors: Achim Autenrieth, Munchen (DE); Claus Gruber, Munchen (DE)

Correspondence Address: STAAS & HALSEY LLP, SUITE 700, 1201 NEW YORK AVENUE, N.W., WASHINGTON, DC, 20005, US

(21) Appl. No.: 11/658,598

(22) PCT Filed: May 24, 2005
(86) PCT No.: PCT/EP05/52377

§ 371 Date: Jan. 26, 2007

(30) Foreign Application Priority Data
Jul. 26, 2004 (DE) 10 2004 036 260.2

(51) Int. Cl. G06F 15/173

(52) U.S. Cl. 709/241

(57) ABSTRACT

A method establishes a connection between a source node and a sing node of a communication network. One or several additional nodes represent nodes of the connection in addition to the source node and the sink node. An end-to-end availability of the connection is determined from one respective availability value of at least the additional node/s of the connection and each individual connection between two respective nodes of the connection.

### CROSS REFERENCE TO RELATED APPLICATIONS

This application is based on and hereby claims priority to Application No. PCT/EP2005/052377 filed on May 24, 2005 and German Application No. 10 2004 036 260.2 filed Jul. 26, 2004, the contents of which are hereby incorporated by reference.

### BACKGROUND

The invention relates to a method for setting up a connection between a source node and a sink node in a communication network, with said connection passing through one or more further nodes.

Information is transmitted in communication networks. A communication network contains nodes and individual connections between in each case two nodes. Information transmitted between two nodes not interconnected by an individual connection is sent over one or more further nodes in each case connected in pairs by an individual connection. Said information can therein be transmitted on a packet-switched or circuit-switched basis. The individual connections between the nodes can be realized via, for example, radio or via electronic or optical transmission. Instances of technologies employed in communication networks include SDH (Synchronous Digital Hierarchy), ATM (Asynchronous Transfer Mode), OSPF (Open Shortest Path First), and MPLS (Multi-Protocol Label Switching).

To safeguard a communication network from network-component outages, which is to say from outages of nodes and/or individual connections, backup switching mechanisms are employed wherein spare capacities are held in reserve in the communication network and deployed in the event of a fault to transport the information around the network components that have suffered an outage. Carriers' contractual partners are often guaranteed by way of arrangements known as Service Level Agreements (SLA) that connections will to a specific extent be fail-safe. From the carriers' viewpoint the communication network's spare capacities must, notwithstanding compliance with the SLA figures, be kept low in order to reduce the costs.

A carrier must insure compliance with the SLA figures when connections are set up. That applies both to connections set up in the course of network planning and to connections set up in an already established communication network. It is customary therefor to calculate probabilities that typical fault scenarios will occur such as, for example, a single or multiple fault affecting the individual connections or single node faults. Said probabilities are dependent on the number and availability of all nodes and individual connections in the communication network. The communication network is in consequence safeguarded by protection schemes from the occurrence of certain probable fault scenarios.

### SUMMARY

One possible object is to disclose an efficient method for setting up a connection between two nodes in a communication network, which method will obviate having to consider fault scenarios for safeguarding a connection.

The investor propose a method to set up a connection between a source node and a sink node in a communication network. Alongside the source node and sink node, the connection's nodes include one or more further nodes. An end-to-end availability of the connection is determined from in each case one availability value of at least the further node(s) of the connection and of each individual connection between in each case two nodes of the connection.

The connection setup can relate to an existing, already established communication network. It is in that case possible in the course of the connection setup to, for example, determine the nodes of the connection that are situated between the source and destination node and/or establish a protection scheme to be used for the connection. The connection setup can, though, relate also to the setting of up a connection between nodes during a communication network's establishment phase, for instance in the course of network planning, in a situation in which, for instance, it must be decided which or, as the case may be, how many nodes there need to be interconnected by which individual connections in order to realize connections exhibiting, where applicable, a specific connection quality.

Availability values are used to determine the connection's end-to-end availability, an availability value being a quantitative measure of the probability that a node or, as the case may be, individual connection will fail. A node can fail owing to, for example, a hardware fault or software error, owing to incorrect operation due to, for example, incorrect configuring, or owing to damage caused to the node's physical link by, for example, an excavator that has cut a cable. Statistics are generally kept about the faults or, as the case may be, outages that have occurred so that the probabilities of outages are known.

The availability values of all the connection's nodes can be included in the end-to-end availability, which means availability values of the source node, destination node, and further node(s), or just the availability values of the further nodes. Availability values of all individual connections between in each case two nodes of the connection are furthermore included in the end-to-end availability. Various computing rules can be used for determining the end-to-end availability from the availability values.

In a development, the connection's end-to-end availability is determined by multiplying the respective availability values. According to said computing rule for determining the end-to-end availability, all availability values included in the end-to-end availability are multiplied together.

According to one embodiment the determined end-to-end availability is compared with a threshold value. It will be a positive indication for the connection if the determined end-to-end availability exceeds the threshold value. A threshold value can derive from, for example, a Service Level Agreement (SLA). The threshold value can possibly be changed dynamically.

It is advantageous for a protection scheme or a plurality thereof to be realized for the connection as a function of the determined end-to-end availability. A realized protection scheme can comprise one protection scheme selected from a plurality of different protection schemes such as, for example, the protection schemes 1+1 and 1:1, or it can be the specific application of a protection scheme or a combination of several protection schemes. Instances of further protection schemes that can be applied include, for instance, path-based protection schemes such as 1:N, !+1, fast reroute, Haskin, local-2-egress, regional, as well as ring-based protection schemes such as, for example, rings, p-cycles, and distributed mechanisms such as, for example, rerouting. A specific application of a protection scheme can relate to, for example, making one or more further connections available between the source node and sink node as a function of the determined end-to-end availability. A further connection of said type can be, for example, an additional connection so that both connections are used simultaneously for transmitting information for an instance of communication between the source and sink node, or it can be a backup connection required and used for transmitting information only if the connection fails. Part of a backup connection of said type can be a backup connection for a plurality of connections between different source and sink nodes. It will be advantageous to make one or more further connections available particularly when the determined end-to-end availability falls below a threshold value.

In a development, an end-to-end availability of another connection between the source node and sink node is determined as a function of the determined end-to-end availability. The end-to-end availability is determined for a plurality of connections between the source and sink node. An especially suitable connection between the source and sink node can be ascertained thereby that can be used at a future time for transmitting information. It is in this way possible to determine one or more connections whose end-to-end availability or, as the case may be, availabilities exceed a specific threshold value.

According to an advantageous development, the availability value of one or more nodes of the connection and/or of one or more individual connections is changed as a function of the determined end-to-end availability. If the connection's end-to-end availability is to be increased, it will thus be possible to increase availability values of the source node and/or sink node and/or of one or more further nodes of the connection and/or one or more individual connections. A node's availability value can be changed by way of, for example, introducing redundancy or control software or software that prevents incorrect configuring. An individual connection's availability value can be changed by way of, for example, changing the connection's excavation depth or cladding or changing the quality of the connection or its loading.

In an embodiment an end-to-end quality of service of the connection is determined alongside its end-to-end availability. An end-to-end quality of service can be defined by consist of, for example, the availability of an end-to-end bit rate. The end-to-end quality of service can be determined in particular using a computing rule embodied analogously for determining the end-to-end availability.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1: shows a communication network.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

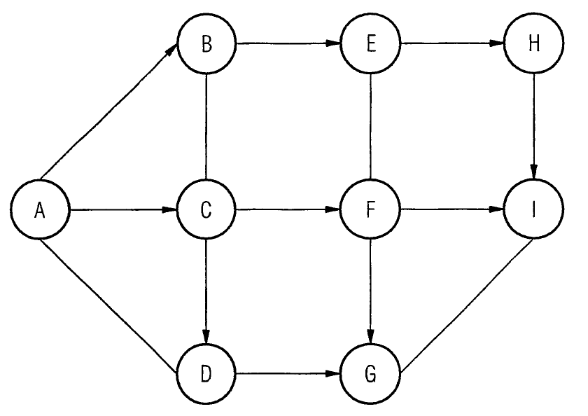

The communication network shown in FIG. 1 contains the nodes A, B, C, D, E, F, G, H, and I. Direct communication is possible in each case between two nodes that are connected by an individual connection, identified in FIG. 1 by a line between the respective nodes. Let the case be considered of a connection's requiring to be set up between the two nodes A and I and between the two nodes C and G, with its being assumed that the carrier guarantees that a connection will not fail for more than 48 hours in a year. That means that each connection's availability must be 0.995, or, as the case may be, that a connection is only allowed to fail with a probability of 0.005.

Availability values are known for all nodes and all individual connections in the communication network. In what is explained below it is assumed for simplicity's sake that the availability value is 0.999 both for the nodes and for the individual connections. The method can, however, also be applied when different availability values apply to different nodes and individual connections.

To insure a connection's availability of 0.995, the probability that certain fault scenarios will occur is calculated according to the related art on the basis of the size of the communication network having 9 nodes and 14 individual connections. The probability p₁ that precisely one fault will occur at an instant in time is:

$${p}_{1} = ( \begin{matrix}23 \\ 1\end{matrix} ) \cdot {0.999}^{22} \cdot {0.001}^{1} = 0.0225 .$$

That exceeds the permitted probabilities of the occurrence of an outage of 0.005.

The probability P₂ that more than one fault will occur simultaneously in the communication network is:

$$\begin{matrix}{p}_{2} = 1 - ( \begin{matrix}23 \\ 0\end{matrix} ) \cdot {0.999}^{23} \cdot {0.001}^{0} - ( \begin{matrix}23 \\ 1\end{matrix} ) \cdot {0.999}^{22} \cdot {0.001}^{1} \\ = 0.00025 .\end{matrix}$$

At a value of 0.00025, the probability that two or more faults will occur simultaneously is below the permitted probability of an outage of 0.005. Each connection, requiring to exhibit the availability of 0.995, between two nodes in the communication system is therefore safeguarded by a further connection in the form of an additional or backup connection between the same nodes. If a connection is to be set up between the nodes A and I, then there will be, for example, a connection via the nodes C and F and a further connection via the nodes B, E, and H, indicated in each case by arrows. For a connection setup between the two nodes C and G there will be a connection via the node F and a further connection via the node D, indicated in each case by arrows.

If a 1+1 protection scheme is used, then information or, as the case may be, messages will be transmitted simultaneously between two nodes over two different connections between said nodes. Messages between the nodes A and I would therefore be transmitted both via the nodes C and F and via the nodes B, E, and H. Besides the connection passing through the nodes C and F, the additional connection via the nodes B, E, and H will be made available and used for message transmission. Messages would be transmitted between the nodes C and G both via the node F and over the additional connection via the node D. That means a double use of resources for a message transmission so that the overall message rate will be decreased.

If a 1:1 protection scheme is used, a message between two nodes will be transmitted only over one connection between said nodes, with there being a backup connection available, however, over which message transmission will take place if the connection fails. The connection between the nodes A and I passing through the nodes B, E, and H thus constitutes a backup connection for the connection via the nodes C and F. Connections between different nodes can at least partially have the same backup connection available because the probability that more than one fault will occur, which is to say that both connections will require the backup connection at the same time, has the low value of 0.00025.

End-to-end availabilities of connections are determined. For the connection between the nodes A and I passing through the two nodes C and F the result for the end-to-end availability A_{AI} is:

A_{AI}=0.999⁷=0.993.

For the connection between the nodes C and G passing through the node F the result for the end-to-end availability A_{CG} is:

A_{CG}=0.999³=0.997.

The end-to-end availability of 0.997 for the connection between the nodes C and F exceeds the minimum required value of 0.995. It is hence not necessary to realize a backup or additional connection for the connection between the nodes C and G passing through the node F. The node D can therefore be used unrestrictedly for other connections.

On the other hand, the end-to-end availability of 0.993 for the connection between the nodes A and I is below the minimum required value of 0.995. A further connection passing through the nodes B, E, and H will therefore be made available alongside the connection between the nodes A and I passing through the nodes C and F. A 1+1 or 1:1 scheme, for example, can be used as the protection scheme as described above.

According to the above-described related art, the spare-capacity requirements are influenced by the communication system's size and all the availability values. Spare capacities are accordingly made available for all connections in equal measure. In contrast to this, the method makes spare capacities necessary and available only for connections whose end-to-end availability falls below a pre-specified threshold value. Thus it is possible according to the method to distinguish between characteristics of special nodes and individual connections forming part of a connection between two nodes. That results in a saving in resources and hence in savings in network costs.

The described calculation of the end-to-end availabilities can be used in different ways during a connection setup. Thus during routing, which is to say when the nodes forming a constituent of the connection are being determined, the end-to-end availability can be included by giving preference to the connections having an as high as possible end-to-end availability. In the above-described example, in which all nodes and individual connections have the same reliability values, that will result in preferring the shortest connections between two nodes. If redundancy or, as the case may be, backup switching methods are used and if resource sharing is included, then as a rule it will not be the shortest paths that are used for the most favorable overall constellation in cost terms.

As a further application of the calculation of the end-to-end availabilities, the availability values of nodes and/or individual connections can be increased in the event of an inadequate end-to-end availability. It is finally, as described above, possible to make spare capacities available as a function of the determined end-to-end availabilities.

As an additional criterion alongside the end-to-end availabilities, it is also possible to use end-to-end qualities of service. Thus, for example, preference can be given to a first connection between two nodes that has a slightly lower end-to-end availability than a second connection between the same nodes but a higher end-to-end quality of service.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method for setting up a connection between a source node and a sink node in a communication network having one or more intermediate nodes between the source node and the sink node, comprising:
determining a nodal availability value of at least one of the intermediate nodes of the connection;
determining connection availability value of each individual connection between, in each case, two nodes; and
determining an end-to-end availability from either the nodal availability values, the connection availability values, or both.

10. The method as claimed in claim 9, wherein
the end-to-end availability of the connection is determined by multiplying the respective availability values.

11. The method as claimed in claim 9, wherein
the determined end-to-end availability is compared to a threshold value.

12. The method as claimed in claim 9, wherein
a protection scheme is realized for the connection as a function of the determined end-to-end availability.

13. The method as claimed in claim 12, wherein
at least two connections between the source node and the sink node are made available as a function of the determined end-to-end availability.

14. The method as claimed in claim 9, wherein
an end-to-end availability of another connection between the source node and the sink node is determined as a function of the determined end-to-end availability.

15. The method as claimed in claim 9, wherein
the nodal availability value, the connection availability value, or both, are changed as a function of the determined end-to-end availability.

16. The method as claimed in claim 9, wherein
an end-to-end quality of service of the connection is determined alongside its end-to-end availability.

17. The method as claimed in claim 10, wherein
the determined end-to-end availability is compared to a threshold value.

18. The method as claimed in claim 17, wherein
a protection scheme is realized for the connection as a function of the determined end-to-end availability.

19. The method as claimed in claim 18, wherein
at least two connections between the source node and the sink node are made available as a function of the determined end-to-end availability.

20. The method as claimed in claim 19, wherein
an end-to-end availability of another connection between the source node and the sink node is determined as a function of the determined end-to-end availability.

21. The method as claimed in claim 20, wherein
the nodal availability value, the connection availability value, or both, are changed as a function of the determined end-to-end availability.

22. The method as claimed in claim 21, wherein
an end-to-end quality of service of the connection is determined alongside its end-to-end availability.
